(19) United States
(12) Patent Application Publication
(10) Pub. No.: US 2003/0068032 A1
(43) Pub. Date: Apr. 10, 2003

(54) Ringing subscriber line interface circuit with full differential analog interface

(75) Inventors: Leonel Ernesto Enriquez, Melbourne Beach, FL (US); Douglas L. Youngblood, Palm Bay, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: INTERSIL AMERICAS INC., Irvine, CA (US)

(21) Appl. No.: 09/971,443

(22) Filed: Oct. 5, 2001

(51) Int. Cl. H04M 1/00; H04M 9/00

(52) U.S. Cl. 379/399.01

(57) ABSTRACT

A fully differentially based analog interface is used to couple a (ringing) subscriber line interface circuit (SLIC) to a dynamic range-constrained circuit, such as a low voltage codec. In the receive direction, and for ringing signal generation, an operational amplifier has its inputs differentially coupled to first and second polarity signal input ports; the amplifier's output is coupled to a single ended node of the internal circuitry of the respective port. In the output signal direction for transmission, a single ended output node of the internal circuitry of the respective SLIC circuit function is coupled to each of a pair of opposite polarity buffer paths, terminated by differential polarity output ports.

### FIELD OF THE INVENTION

The present invention relates in general to electronic circuits, and is particularly directed to a differentially based, reduced circuit complexity, analog interface for coupling a (ringing) subscriber line interface circuit (SLIC) to a dynamic range-constrained circuit, such as a low voltage codec.

### BACKGROUND OF THE INVENTION

A number of systems and subsystems of communication service providers contain what are known as subscriber line interface circuits, or ‘SLIC’s, that interface communication signals with tip and ring leads of a wireline pair serving a variety of subscriber telecommunication equipments. A non-limiting example of a typical commercially available (ringing) SLIC design is shown in the block diagram of FIG. 1, as comprising a first, two-wire transceiver port 10, having its TIP and RING ports 11 and 12, that are coupled to a telephone two-wire pair 15, and a second, four-wire transceiver port 20, respective (single ended) transmit (TX) and receive (RX) ports V_{TX} and V_{RX} of which are coupled to a codec 25. The SLIC further includes a ringing signal port 30 having a (single ended) ringing signal (V_{RS}) port, and being coupled to the two-wire and four-wire transceiver ports 10 and 20, and also to a battery switch 40 (coupled to respective high and low battery terminals V_{BH} and V_{BL}), DC control for which is provided by a DC control circuit 50, which is also coupled to two-wire port 10.

A transmit sensing circuit 60 is coupled to each of the two-wire and four-wire ports 10 and 20, as well as a detector logic circuit 70, and a control logic circuit 80, which is coupled to each of the four-wire port 20 and the detector logic circuit 70. Associated with the two-wire port 10 is a transient current limit circuit 90, which is coupled to the transmit sensing circuit 60 and an internal loop back circuit 100, to which the detector logic 70 is coupled. As the functionality and operation of the various components of the SLIC diagram of FIG. 1 are conventional, no additional illustration or further description of the details thereof will be provided here.

Suffice it to say, however, that in order to be used with a variety of telecommunication circuits, including those providing codec functionality, present day SLICs, such as but not limited to that shown in FIG. 1, must conform with a very demanding set of performance requirements, including accuracy, linearity, filtering, insensitivity to common mode signals, low noise, low power consumption, and ease of impedance-matching programmability. In addition, as designers of integrated circuits employed in digital communication applications, such as codecs and the like, continue to ‘lower the voltage supply rail’ used to power their devices (e.g., from five volts down to three volts), the communication service provider is faced with the challenge that such low voltage restrictions may not enable the (codec) input signals to the SLIC to satisfy minimum industry standard amplitude signal deflection requirements. Another difficulty is the fact that many digital signal processor (DSP)-based codec designs suffer from a substantial amount of ground noise, which further exacerbates the SLIC's already limited voltage headroom problem.

### SUMMARY OF THE INVENTION

Pursuant to the invention, these issues are successfully addressed by configuring all of respective signalling (e.g., transmit, receive and ringing ports) as (reduced complexity) differentially based analog interface ports. To implement a pair of differential receiver input ports, such as may be employed in place of the single ended receiver input to the four-wire transceiver port of the SLIC of FIG. 1, an operational amplifier has its inputs differentially coupled to first and second polarity signal input ports. The amplifier's output is coupled through a coupling impedance to a single ended node of the internal circuitry of the respective port. The resistor values are selected in accordance with the intended amplifier gain and impedance matching characteristics. With SLIC's inputs from upstream codec components being differentially polarity coupled, the extremely limited headroom and dynamic range associated with a reduced voltage rail driven codec can now be increased to fall within an acceptable range by back-to-back summation of the signal inputs. Also, differential combining causes mutual cancellation of common mode noise signals, so as to improve the effective signal-to-noise ratio of the codec's input signal seen by the SLIC.

In the output signal direction, a single ended output node of the internal circuitry of the SLIC circuit function is coupled to each of a pair of opposite polarity signal buffer paths, which are terminated by differential polarity output ports, respectively. The first output path contains a first inverting buffer amplifier, while second output path is coupled through a pair of cascaded amplifiers, each of which has a circuit configuration corresponding to that of the first path. This provides the necessary buffering and impedance matching properties and ensures that the signals presented to the two output ports are antiphase for fully differential operation.

### BRIEF DESCRIPTION OF THE DRAWINGS

FIG. 1 is a block diagram of a conventional (ringing) subscriber line interface circuit;

FIG. 2 is a modification of the block diagram of a (ringing) subscriber line interface circuit of FIG. 1 to incorporate differentially based signal coupling ports pursuant to the present invention;

FIG. 3 is a schematic diagram of a differentially based signal input interface employed in the subscriber line interface circuit of FIG. 2; and

FIG. 4 is a schematic diagram of a differentially based signal output interface employed in the subscriber line interface circuit of FIG. 2.

### DETAILED DESCRIPTION

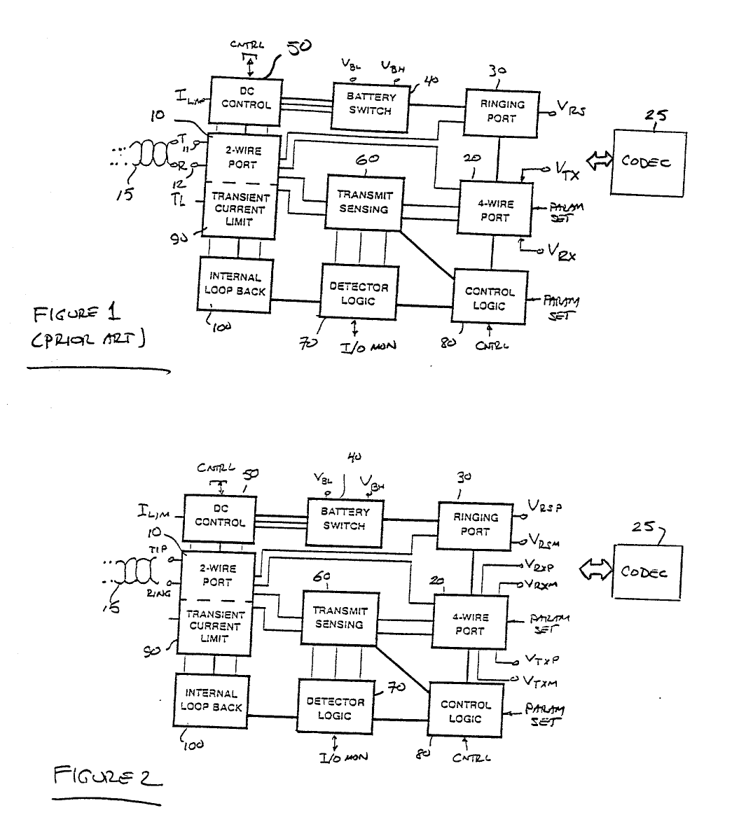

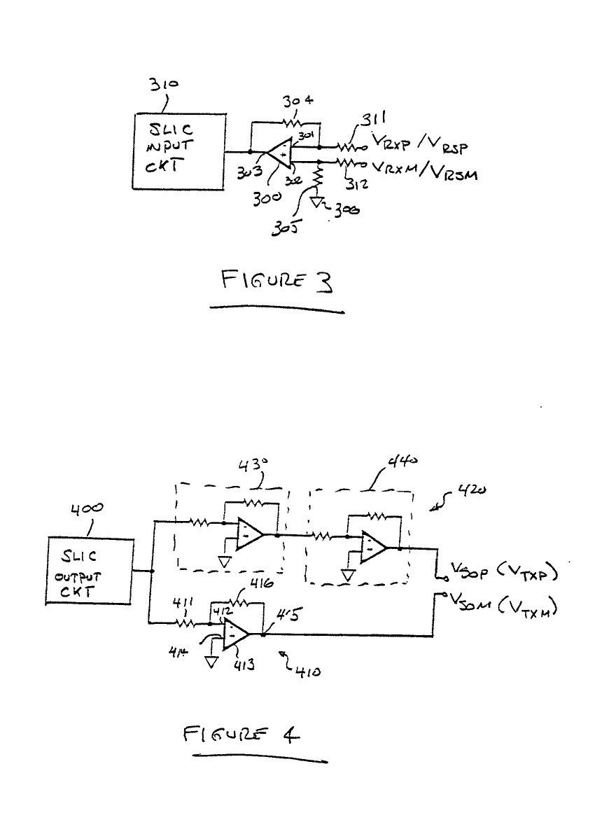

As described briefly above, the subscriber line interface circuit of the present invention successfully addresses limited dynamic range and ground noise problems associated with low voltage codecs (such as DSP-based codecs) by converting each of SLIC's single ended, low voltage interface, signalling ports (e.g., its transmit, receive and ringing ports) to differentially based analog interface ports. As shown in the block diagram of FIG. 2, using the case of the SLIC architecture of FIG. 1, as a non-limiting example, the invention replaces the single ended ringing signal output port V_{RS} with a pair of differentially based ringing signal output ports V_{RSP} and V_{RSM}. It also replaces the single ended transmitter output port V_{TX} with a pair of differential transmit output ports V_{TXP} and V_{TXM}, and the single ended receiver input port V_{RX} with a pair of differential receiver input ports V_{RXP} and V_{RXM}.

FIG. 3 is a schematic diagram of a relatively reduced circuit complexity, differential input, single ended output interface that may be employed to implement the differential receiver input ports V_{RXP} and V_{RXM} of the modified four-wire transceiver port 20 of FIG. 2. This circuit may also be employed to implement the differential ringing input ports V_{RSP} and V_{RSM} of the modified ringing port 30 of FIG. 2.

As shown therein the differential input, single ended output interface comprises an (inverting) operational amplifier 300 having an inverting polarity (−) input 301 thereof coupled through an input resistor 311 to a first signal input port V_{RXP}, and a non-inverting (+) input 302 coupled through an input resistor 322 to a second signal input port V_{RXM}. The non-inverting (+) input 302 is further coupled through a resistor 305 to a reference potential terminal 306 (such as ground (GND)). The amplifier's output 303, which is coupled to a single ended node of the internal circuitry 310 of the respective port, is coupled through a feedback resistor 304 to its inverting (−) input 301. The respective resistor values are selected in accordance with the intended amplifier gain and impedance matching characteristics.

Since the SLIC's inputs from upstream codec components are differentially polarity coupled, they enable the extremely limited headroom and dynamic range associated with a reduced voltage rail driven codec to be increased to fall within an acceptable range by back-to-back summation of the signal inputs. Moreover, differential combining readily cancels common mode noise signals, so as to improve the effective signal-to-noise ratio of the codec's input signal seen by the SLIC.

In the output signal direction (such as for the transmit ports), the single ended input to differential output interface of FIG. 4 may be employed. As shown therein, a single ended output node of internal circuitry 400 of the SLIC circuit function is coupled to each of a pair of opposite polarity signal buffer paths 410 and 420, which are terminated by differential polarity output ports V_{SOM} and V_{SOP}, respectively. For the SLIC example of FIG. 2, the signal output port V_{SOP} may correspond to transmit output port V_{TXP}, while the complementary polarity signal output port V_{SOM} may correspond to complementary polarity transmit output port V_{TXM}.

The first output path 410, which is terminated by the output signal port V_{SOM}, is coupled through an input resistor 411 to the inverting (−) input 412 of an operational amplifier 413. The non-inverting input 414 of amplifier 413 is coupled to ground (GND) . The amplifier's output 415 is coupled through a feedback resistor 416 to its inverting (−) input 412. As in the case of the interface of FIG. 3, described above, the respective resistor values are selected in accordance with the intended amplifier gain and impedance matching characteristics.

The second output path 420, which is terminated by the output signal port V_{SOP}, is coupled through a pair of cascaded amplifiers, shown in broken lines 430 and 440, each of which has a circuit configuration corresponding to that of the first path 410, described above. This serves to provide the necessary buffering and impedance matching properties at the output ports V_{SOP} and V_{SOM}, as well as ensuring that the signals presented to the two output ports are antiphase for fully differential (common mode noise rejecting) operation.

While we have shown and described an embodiment in accordance with the present invention, it is to be understood that the same is not limited thereto but is susceptible to numerous changes and modifications as known to a person skilled in the art. We therefore do not wish to be limited to the details shown and described herein, but intend to cover all such changes and modifications as are obvious to one of ordinary skill in the art.

What is claimed

1. An interface for coupling a subscriber line interface circuit (SLIC) to transmit and receive paths of a digital communication circuit comprising:
a pair of differential receiver input ports configured to be differentially coupled to the transmit path of said digital communication circuit;
a differential-to-single ended input circuit, coupling said differential receiver input ports to receiver circuitry of said SLIC;
a pair of differential transmitter output ports configured to be differentially coupled to the receive path of said digital communication circuit; and
a single ended-to-differential output circuit, coupling transmitter circuitry of said SLIC to said differential transmitter output ports.

2. The interface according to claim 1, further comprising a pair of differential ringing signal ports, and a differential-to-single ended input circuit, coupling ringing signal circuitry of said SLIC to said differential ringing signal ports.

3. The interface according to claim 1, wherein said differential-to-single ended input circuit comprises an operational amplifier having differential polarity inputs respectively coupled to said differential receiver input ports, and an output thereof coupled to said receiver circuitry of said SLIC.

4. The interface according to claim 1, wherein said single ended-to-differential output circuit comprises a pair of opposite polarity signal buffer paths terminated by respective ones of said pair of differential transmitter output ports.

5. The interface according to claim 4, wherein said pair of opposite polarity signal buffer paths comprises a first output buffer path containing a first inverting buffer amplifier, and a second output buffer path containing a pair of cascaded inverting buffer amplifiers.

6. The interface according to claim 2, wherein said differential-to-single ended input circuit comprises an operational amplifier having differential polarity inputs respectively coupled to said differential input ports, and an output thereof coupled to ringing circuitry of said SLIC.

7. A method of coupling a subscriber line interface circuit (SLIC) to communication paths of a digital communication circuit comprising the steps of:
(a) providing plural pairs of differential signaling ports that are configured to be differentially coupled to respective signaling paths of said digital communication circuit; and
(b) coupling respective ones of said plural pairs of differential signaling ports through respective interface circuits to single ended nodes of associated transceiver components of said SLIC.

8. The method according to claim 7, wherein
step (a) comprises providing a pair of differential receiver input ports that are configured to be differentially coupled to the transmit path of said digital communication circuit, and a pair of differential transmitter output ports configured to be differentially coupled to the receive path of said digital communication circuit, and wherein
step (b) comprises coupling said pair of differential receiver input ports through a differential-to-single ended input circuit to receiver circuitry of said SLIC, and coupling transmitter circuitry of said SLIC through a single ended-to-differential output circuit to said pair of differential transmitter output ports.

9. The method according to claim 8, further comprising the step (c) of coupling ringing signal circuitry of said SLIC to differential ringing signal ports through a differential-to-single ended input circuit.

10. The method according to claim 8, wherein said single ended-to-differential output circuit comprises a pair of opposite polarity signal buffer paths terminated by respective ones of said pair of differential transmitter output ports.

11. The method according to claim 10, wherein said pair of opposite polarity signal buffer paths comprises a first output buffer path containing a first inverting buffer amplifier, and a second output buffer path containing a pair of cascaded inverting buffer amplifiers.

12. The method according to claim 9, wherein said differential-to-single ended input circuit comprises an operational amplifier having differential polarity inputs respectively coupled to said differential input ports, and an output thereof coupled to ringing circuitry of said SLIC.
